(19) United States
(12) Patent Application Publication
(10) Pub. No.: US 2023/0064805 A1
(43) Pub. Date: Mar. 2, 2023

(54) METHOD FOR PRODUCING A WORKPIECE, IN PARTICULAR A TURBINE BLADE, USING A MILLING TOOL

(71) Applicant: OPEN MIND TECHNOLOGIES AG, Wessling (DE)

(72) Inventors: Josef KOCH, Muenchen (DE); Peter BRAMBS, Muenchen (DE)

(73) Assignee: OPEN MIND TECHNOLOGIES AG, Wessling (DE)

(21) Appl. No.: 17/799,222

(22) PCT Filed: Feb. 5, 2021
(86) PCT No.: PCT/EP2021/052777

§ 371 Date: Aug. 11, 2022

(30) Foreign Application Priority Data
Feb. 11, 2020 (DE) 10 2020 000 882.8

(51) Int. Cl. B23C 3/18; B23C 5/10

(52) U.S. Cl. CPC B23C 3/18; B23C 5/10; B23C 2210/084; B23C 2220/605; B23C 2265/08

(57) ABSTRACT

A method for manufacturing a workpiece (28) using a milling cutter configured as a conically convex milling cutter (10) is provided. The conically convex milling cutter (10) comprises a shank (12) and a conically convex milling cutter portion (14) connected at the end to the shank (12) directly or through a transition (16). The conically convex milling cutter (10) has a first and a second cutting area (24, 26), wherein the first cutting area (24) is provided on the shank (12) or/and at the transition (16), and wherein the second cutting area (26) is provided on the conically convex milling cutter portion (14). The method comprises the following steps:
A) roughing a blank portion (30) using the conically convex milling cutter (10), wherein the latter is inclined relative to a current feed direction (40) at a reference point (38) of the conically convex milling cutter (10) within a first machining angle range (α1, β1) such that machining is performed with the first cutting area (24) of the conically convex milling cutter (10), wherein the second cutting area (26) remains passive during machining, and
B) finishing at least a part of the rough blank portion (46) using the conically convex milling cutter (10), wherein the latter is inclined relative to the current feed direction (40) at the reference point (38) of the conically convex milling cutter (10) within a second machining angle range (α2, β2) in such a way that machining is performed with the second cutting area (26) of the conically convex milling cutter (10), wherein the second cutting area (26) engages with the blank (30).

The invention relates to a method for manufacturing a workpiece, in particular a turbine blade, using a milling tool.

As is known, manufacturing a workpiece using a milling tool involves several steps including the steps of roughing and finishing. This is understood to mean machining a blank by removing material by cutting, whereby the blank is roughly machined during roughing and finely machined during finishing so that the material removal is comparatively greater during roughing while the surface quality obtained is significantly lower. Optionally, roughing and/or finishing may be preceded by a preparatory step.

As material removal during roughing and finishing differs, it is necessary to adapt the milling tool to be used for the respective step. For this purpose, two different milling cutters may be used, for example a milling cutter with tooth-like cutting edges for roughing and a milling cutter without tooth-like cutting edges for finishing. However, this comes with the disadvantage that the milling tool needs be changed between the steps mentioned, which increases the total machining time from the blank to the completed workpiece.

The wish to shorten machining time by avoiding changing the milling cutter is well known in the prior art. For example, U.S. Pat. No. 6,077,002 A suggests that different cutting areas of a ball-end milling cutter be used for roughing and finishing in order to machine different component areas. For this purpose, the ball-shaped head of the milling cutter is configured with teeth for roughing a groove in the component whereas side faces of the shank adjoining the ball-shaped head are configured without teeth for finishing side walls of the groove. It is understood that for this application the shank of the milling cutter must be guided parallel to the surface to be finished, which means that not all areas of a blank are accessible.

In particular for the machining of blade-shaped workpieces, which involves a high risk of vibrations caused by milling, CH 661 678 A5 proposes a milling cutter in which material removal takes place with a face milling cutter and a peripheral milling cutter combined in one milling tool. In this process, the shank of the milling cutter (peripheral milling cutter) first enters the raw material before the milling cutter machines a part of the raw material using face milling and then another part of the raw material using peripheral milling. This means that different areas of the workpiece are machined during circumferential milling and face milling. CH 661 678 A5 does not show an application of a specific milling cutter portion for a specific machining step, such as roughing or/and finishing. Although a use of a milling cutter combining two milling cutter areas brings a time advantage, the areas overlap in the method disclosed in CH 661 678 A5, which reduces the service life of the milling cutter.

Another approach to providing a method for manufacturing blade-shaped workpieces can be taken from US 2017/095865 A1. In the method disclosed in this document, severe tool wear is reduced by no longer machining the workpiece along large areas, but instead sequentially removing material from the workpiece in smaller areas. On the one hand, this increases the stability of the material to be machined during machining, and on the other hand, it protects the tool. In addition, it is not necessary to change the tool since the desired material removal is adapted in such a way that the same cutting areas of a ball-end milling cutter may be used. A disadvantage of this method, however, is that the milling cutter is neither rough enough for removing a large amount of material during roughing nor fine enough for achieving a high surface quality during finishing. The achievable surface quality may therefore not be acceptable or it may be necessary to perform a further fine machining step after finishing.

Reference is made to document DE 10 2016 117 932 A1 as further prior art.

Based on this prior art, the present invention is based on the task of providing a method for manufacturing a workpiece that enables efficient machining of a blank by roughing and finishing to form a workpiece, in particular a turbine blade, while protecting the milling tool.

The task is solved using a method for manufacturing a workpiece, in particular a turbine blade, using a milling cutter that is configured as a conically convex milling cutter. The conically convex milling cutter comprises a shank and a conically convex milling cutter portion connected at the end to the shank directly or through a transition, wherein the conically convex milling cutter has a first and a second cutting area, wherein the first cutting area is provided on the shank or/and on the transition, and wherein the second cutting area is provided on the conically convex milling cutter portion. The method comprises the following steps:
A) roughing a blank portion using the conically convex milling cutter, wherein the latter is inclined relative to a current feed direction at a reference point of the conically convex milling cutter within a first machining angle range such that machining is performed with the first cutting area of the conically convex milling cutter, wherein the second cutting area remains passive during machining, and
B) finishing at least a part of the rough blank portion using the conically convex milling cutter, wherein the latter is inclined relative to the current feed direction at the reference point of the conically convex milling cutter within a second machining angle range in such a way that machining is performed with the second cutting area of the conically convex milling cutter, wherein the second cutting area engages with the blank, in particular its rough blank portion, for machining.

The method according to the invention stands out by enabling efficient machining of a blank by roughing and finishing to manufacture a workpiece whose total machining time is short since it is not necessary to change the milling cutter for the mentioned steps of the method. This means that according to the invention, one and the same milling cutter may be used for both machining steps. In addition, the method according to the invention enables the conically convex milling cutter to be used gently by using different cutting areas for machining that are specifically adapted to the respective intended purpose.

In particular, since machining during roughing takes place with the first cutting area of the conically convex milling cutter, and machining during finishing takes place with the second cutting area of the conically convex milling cutter, different cutting areas of the conically convex milling cutter are subject to stress depending on the method step, which protects the conically convex milling cutter and thus increases its service life.

In the following, the terminology used in the application will be explained in more detail with regard to specifically used terms. Where reference is made in this application to a blank, such blank may be of any material to be machined by roughing and/or finishing. A blank processed by roughing is referred to as a rough blank, and a blank processed by roughing and finishing is referred to as a rough and finished blank, and a rough and finished blank may equally be referred to as a workpiece if roughing and finishing were performed on all of the blank portions to be machined.

For example, roughing may also be a pre-finishing operation, or both pre-finishing and roughing may be performed prior to finishing. Furthermore, supplementary preparation may be carried out before roughing or pre-finishing to prepare the leading and trailing edges into and out of the blank.

Feed direction generally refers to a relative direction of movement between the milling cutter and the blank, here meaning a direction in which material removal occurs. The feed direction may also be perpendicular to a surface normal at a current machining point of the blank.

A defined point on the conically convex milling cutter may be chosen as the reference point. The reference point may be defined, for example, on an end flank or tip facing away from the shank, e.g. the foremost tip, of the conically convex milling cutter portion. The reference point may also be any point on the axis of the conically convex milling cutter, for example an outermost or foremost point of any additional ball-shaped tip on the conically convex milling cutter portion.

The above-mentioned machining angle ranges for roughing and finishing preferably include all angle settings of the milling cutter that enable the milling operations specified in step A) and B). This preferably includes any camber angles and lateral inclination angles in relation to the feed direction of the conically convex milling cutter, which will be described in more detail later.

Advantageously, the area of application of the milling cutter is not limited to certain blank or workpiece geometries. This may be achieved by the conically convex milling cutter being variably movable within the first machining angle range and the second machining angle range, respectively, during the A) roughing and B) finishing steps.

The first and second machining angle ranges may overlap or be adjacent to each other. Alternatively, the machining angle ranges may be spaced from each other by an amount. This makes it possible to always choose the suitable machining angle range that enables roughing and finishing as described above. This means that the method may be used flexibly for different blank or workpiece geometries.

The manufacture of narrow, long components, such as a turbine blade, comes with the risk that the blank will vibrate during machining due to its geometry and the related lack of stability, which may lead to higher manufacturing tolerances when manufacturing the workpiece. Such risk may be avoided if the A) roughing and B) finishing steps are carried out alternately in different, preferably adjacent, blank portions. This ensures that blank portions with larger dimensions are available over a comparatively long machining time, which counteract material vibrations. Such process guiding hence serves to increase the quality and efficiency of the method.

As explained at the beginning, the milling cutter may be inclined within machining ranges. One possibility here is that during roughing (step A)), the conically convex milling cutter is tilted at a first camber angle in the direction of the current feed direction of the conically convex milling cutter within the first machining angle range. Tilting the conically convex milling cutter by the first camber angle enables to perform roughing with the first cutting area while the second cutting area remains passive. This may ensure that the second cutting area intended for finishing is protected during roughing, thus increasing the overall service life of the conically convex milling cutter.

The camber angle is generally defined between a longitudinal axis of the milling cutter and a surface normal of the rough blank or the rough and finished blank or the workpiece, i.e. preferably the surface formed through roughing or/and finishing, in the feed direction at a current machining point.

Preferably, the camber angle is greater than the circumferential surface angle of the conically convex milling cutter portion to ensure that the conically convex milling cutter portion remains passive during roughing. The amount by which the camber angle may be greater than the circumferential surface angle may depend on a radius of curvature (described later) of the conically convex milling cutter portion. For example, the smaller the radius of curvature, i.e. the greater the curvature of the conically convex milling cutter portion, the larger the amount may be. The circumferential surface angle may be calculated as
circumferential surface angle=90°−cone angle,
where the cone angle may be defined as the angle between a cone underlying a circumferential surface of the conically convex milling cutter and a longitudinal axis through the conically convex milling cutter, wherein the circumferential surface of the underlying cone, the longitudinal axis, and a line perpendicular to the longitudinal axis enclose a triangular surface.

Effective finishing with the second cutting area may be achieved by tilting the conically convex milling cutter at a second camber angle in the direction of a feed direction of the milling cutter in step B) during finishing within the second machining angle range.

The first or/and second camber angle may change during the machining of a blank or rough blank depending on the geometry of the blank to be achieved.

A further possibility of inclining the conically convex milling cutter within its machining angle ranges may be that in step A), the conically convex milling cutter is inclined laterally with respect to the feed direction at a first inclination angle during roughing within the first machining angle range or/and that in step B), the milling cutter is inclined laterally with respect to the feed direction at a second inclination angle during finishing within the second machining angle range.

The inclination angle is generally defined between the longitudinal axis of the milling cutter and the surface normal of the rough blank or the rough and finished blank or the workpiece, i.e. preferably the surface formed through roughing or/and finishing, laterally with respect to the feed direction at a current machining point. The lateral inclination of the milling cutter in step A) or/and step B) by the first or second inclination angle, which preferably refers to the feed direction, may optionally be a lateral inclination to the left or right.

In an analogous manner, the mentioned inclination brings the advantages previously discussed with regard to the first and second camber angle. This means that adjusting the first inclination angle may help to protect the tool and increase the service life of the conically convex milling cutter and/or promote more efficient roughing.

Furthermore, depending on the blank geometry, lateral inclination, i.e. inclination at the first inclination angle, may improve the cutting conditions, support the engagement of the corresponding cutting areas or/and also help to avoid collisions.

In a preferred embodiment of the method, the conically convex milling cutter may be tilted about the first camber angle during roughing and inclined about the second inclination angle during finishing, while preferably inclination about the first inclination angle during roughing and tilt about the second camber angle of the conically convex milling cutter during finishing are optional.

Preferably, the shank or/and the transition of the conically convex milling cutter does/do not touch the rough blank during finishing. However, where allowance is somewhat larger during roughing, the shank or/and the transition may also engage with material of the rough blank during finishing. In such case, the shank or/and the transition will perform roughing rather than finishing.

For example, in one embodiment, during roughing in step A) within the first machining angle range, the conically convex milling cutter is tilted in the direction of a feed direction of the conically convex milling cutter at a first camber angle and, during finishing in step B) within the second machining angle range, it is inclined laterally with respect to the feed direction at a second inclination angle.

In a further embodiment, the first inclination angle during roughing may preferably be smaller than the second inclination angle during finishing.

The first and second inclination angle may vary depending on the contour of the blank or rough blank or workpiece during machining. The first inclination angle during roughing should be chosen such that the conically convex milling cutter portion remains passive. Generally, the first inclination angle, the second inclination angle, the first camber angle or/and the second camber angle may be adjusted independently of each other.

As is generally known, milling methods involve a relative movement between the milling cutter and the blank to be machined, whereby the milling cutter removes collected material from the blank. To generate the relative movement, only the milling cutter, only the blank or both may move. However, a critical component is how such relative movement takes place. With reference to the method disclosed herein, it is proposed that in step A) during roughing or/and in step B) during finishing, the relative movement between the conically convex milling cutter and the blank takes place continuously, wherein the conically convex milling cutter is continuously guided around the blank or the rough blank, or/and the blank or the rough blank are continuously guided relative to the conically convex milling cutter along defined milling paths. The defined milling paths may be completely circumferential or/and interrupted or/and connected through connecting paths.

The continuous relative movement enables time-saving machining of the raw material since the milling cutter is continuously positioned relative to the material to be removed and thus no machining time is required, for example for repositioning the milling cutter.

Furthermore, the milling paths may essentially be the same in step A) during roughing and in step B) during finishing but usually differ from each other. The milling method may be optimized by specifically adapting the milling paths to the geometry of the milling cutter's cutting area provided for the respective step of the method. The milling paths may be calculated for each of steps A) and B) depending on various parameters, such as tool geometry, machining angle, roughing allowance or/and required surface quality after finishing. The conically convex milling cutter may, for example, be continuously guided around the blank, preferably with permanent contact between the milling cutter and the blank.

Milling paths may be visualized by displaying the path of a specific reference point on the milling cutter. The reference point may be the reference point mentioned at the beginning. Thus, a defined point on the conically convex milling cutter may be chosen as the reference point. For example, the reference point may be defined on an end flank or tip facing away from the shank, e.g. the foremost tip, of the conically convex milling cutter portion. The reference point may also be any point on the longitudinal axis of the conically convex milling cutter, for example an outermost or foremost point of an additional ball-shaped tip on the conically convex milling cutter portion.

The milling paths which the conically convex milling cutter moves along during roughing or/and finishing of the blank may be spiral or helical. This ensures continuous machining of the blank or a portion of the blank, preferably with the milling cutter being continuously in contact with the workpiece and performing one of the steps of roughing or finishing.

Alternatively, the milling paths created by the conically convex milling cutter during roughing or/and finishing of the blank may run in one plane. The milling paths may also be separate from each other and connected through connecting paths, whereby the milling tool may not touch the blank when moving along the connecting paths.

Furthermore, the milling paths may be spaced apart by a defined path distance in step A) during roughing and in step B) during finishing, whereby the path distances may be identical or differ from each other in step A) during roughing and in step B) during finishing.

The path distance influences, for example, the contour of the surface, for example a surface structure. It is understood that a larger path distance results in a surface that is more contoured than a smaller path distance. If, for example, a larger path distance is chosen during roughing, material removal during finishing will be higher. Choosing the path distance may thus also be used to determine to how much stress the areas of the milling cutter are subjected to during machining. Therefore, a suitable choice of the path distance may help to achieve the desired protection of the tool and thus a longer service life of the tool.

Another parameter that influences the surface structure after machining of the blank is the roughing allowance, which describes the distance between a surface of the rough blank and the desired final contour of the workpiece. Depending on the choice of the roughing allowance during roughing, material removal during subsequent finishing may be influenced. This is thus another parameter that may affect the stress on the milling cutter. If, for example, the roughing allowance is relatively large, there may be comparatively more material of the blank after roughing to be removed during finishing, and consequently the first cutting area of the milling cutter may contact the rough blank in certain areas of the rough blank during finishing.

Favorable embodiments of the conically convex milling cutter are described below that enable to carry out the method disclosed herein in a particularly favorable manner.

For example, the aforementioned cone angle between a longitudinal axis of the milling cutter and the circumferential surface of the cone underlying the conically convex milling cutter portion may be within an angular range of 50° to 85°. This angular range allows the first cutting area to engage effectively and the second cutting area to remain passive within the first machining angular range during roughing in a favorable manner. Particularly preferably, the cone angle is about 50° to 85°, which enables a wide variety of blank or workpiece geometries to be machined.

As mentioned at the beginning, the first cutting area of the conically convex milling cutter is provided at the shank or/and at the transition between the shank and the conically convex milling cutter portion. Ideally, a ratio of a transition radius to a shank diameter is between 0% and 30%, wherein, ideally, a transition radius of 0% means that there is no transition radius between the shank and the conically convex milling cutter portion.

A conically convex milling cutter that proves to be particularly favorable, for example for machining turbine blades, may have a shank diameter between 4 mm and 25 mm, preferably between 9 mm and 15 mm, particularly preferably between 11 mm and 13 mm. In another particularly preferred embodiment, the shank diameter may be approx. 12 mm.

Furthermore, for example, a curvature radius of the conically convex milling cutter portion of between 400 mm and 600 mm, preferably between 450 mm and 550 mm, particularly preferably of approx. 500 mm, proved to be favorable since this ensures particularly effective use of the second cutting area. Material removal as well as the total machining time are optimized.

The above-mentioned advantage is equally achieved when, ideally, a ratio of a curvature radius of a peripheral surface of the conically convex milling cutter portion to a shank diameter of the milling cutter is 2 to 50.

Depending on the application, the transition between the shank and the conically convex milling cutter portion may be continuous, gradual or sharp. A choice that is adapted to the blank to be machined may reduce the wear of the milling cutter and thus increase its service life.

It is understood that the transition may preferably be configured as a radius or free curve, meaning that there does not have to be a defined radius.

In general, the shank of the milling cutter for carrying out the method according to the invention may be configured essentially cylindrical. Alternatively, the shank may be configured substantially conical, in the case of which the shank merges into the conically convex milling cutter portion directly or with the aforementioned transition. Further, the shank of the milling cutter may be composed of a cylindrical portion and an adjoining conical portion, which is referred to as a conical-cylindrical shank. For example, the shank may have a substantially cylindrical portion and then merge into a rounded transition or directly into a conical portion and subsequently merge from this conical portion directly or through the aforementioned transition into the conically convex milling cutter portion. Further, the shank may be composed of a plurality of different portions, for example having a substantially cylindrical portion which then merges into a conical portion, the shank again merging from this conical portion into a cylindrical portion which then merges into the conically convex milling cutter portion directly or through the aforementioned transition. Direct or rounded transitions between the individual shank portions as well as shank portions having curved outer profiles are alternatives according to the invention.

Further, the effectiveness of machining a blank may be improved by having the conically convex milling cutter portion taper toward a tip or end face, or by having an additional ball-shaped tip at the exposed end of the conically convex milling cutter portion.

In the following, the present invention is described by way of example with reference to the accompanying figures. The drawing, the specification and the claims contain combinations of numerous features. The skilled person will appropriately consider the features also individually and use them in useful combinations within the scope of the claims.

In the drawings:

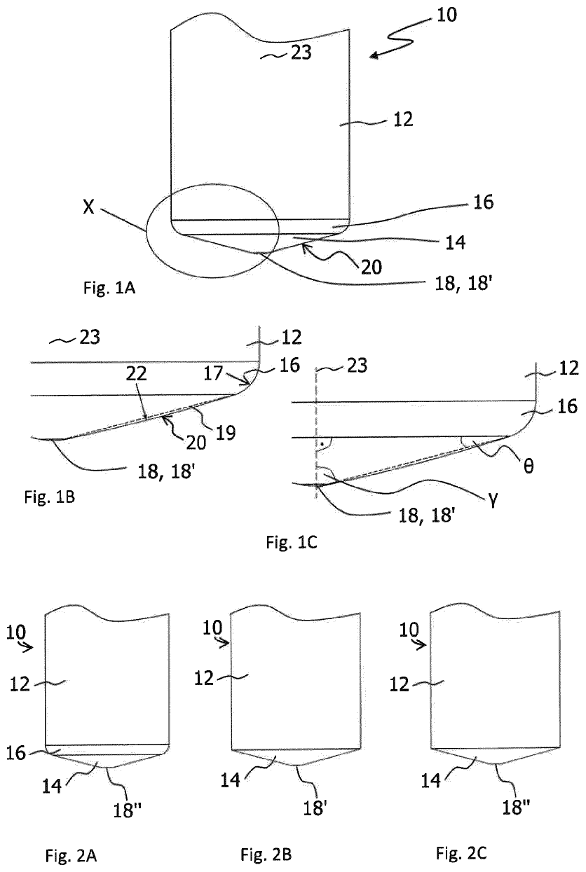

FIGS. 1A-1C are a side view of a conically convex milling cutter in FIG. 1A and an enlargement of section X of the conically convex milling cutter of FIG. 1A in FIGS. 1B and 1C;

FIGS. 2A-2C are embodiments of a conically convex milling cutter with (FIG. 2A) and without (FIG. 2B, 2C) a transition as well as with (FIG. 2B) and without (FIGS. 2A and 2C) a ball-shaped tip;

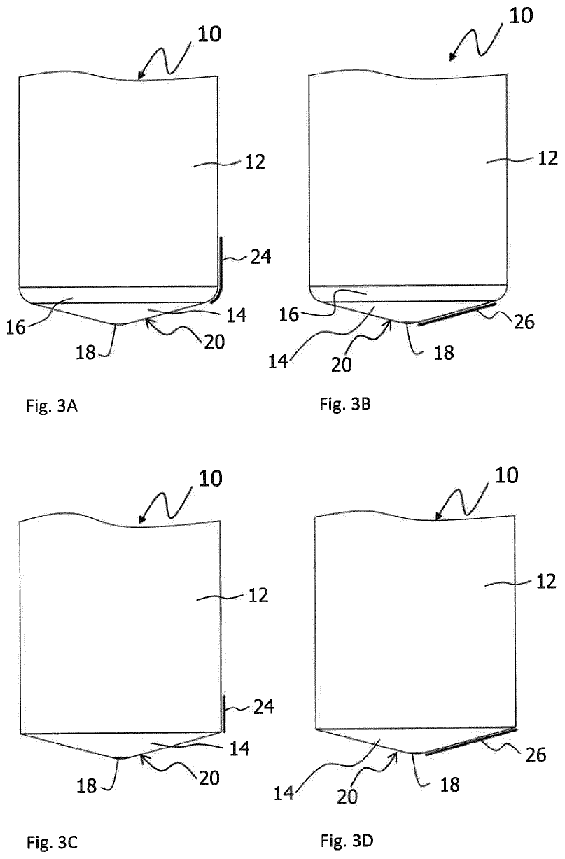

FIGS. 3A-3D are side views of a conically convex milling cutter with (FIGS. 3A and 3B) and without (FIGS. 3C and 3D) a transition as well as an illustration of a first (FIGS. 3A and 3C) and a second cutting area (FIGS. 3B and 3D);

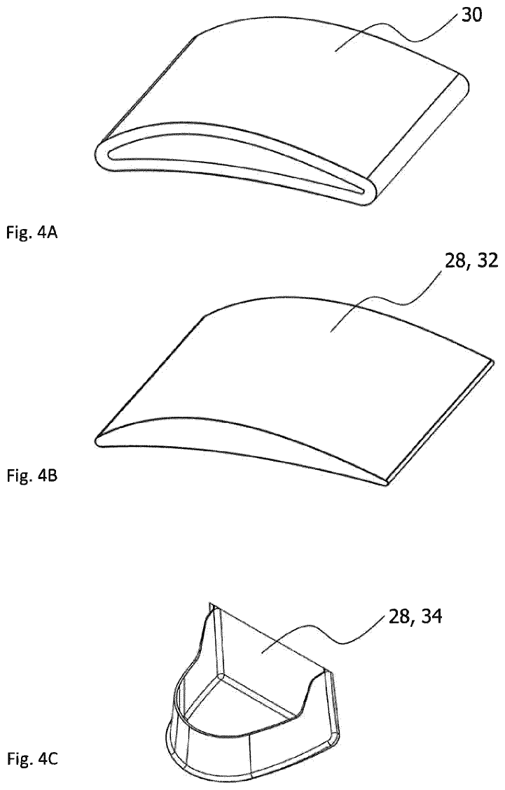

FIGS. 4A-4C are examples of workpieces machined using the method according to the invention in the form of a turbine blade (FIG. 4A) with the corresponding blank (FIG. 4B) and an aerospace part (FIG. 4C);

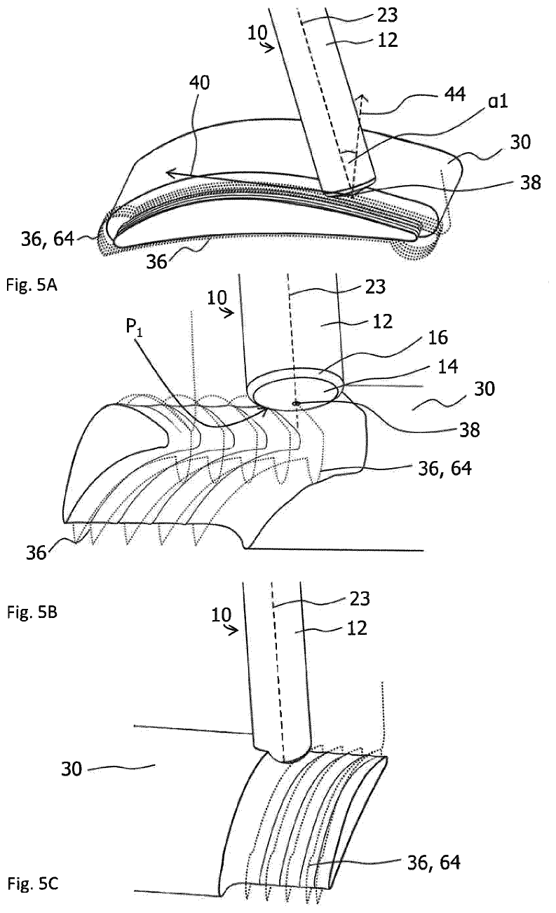

FIGS. 5A-5C are illustrations of roughing a blank portion using a conically convex milling cutter at a machining point using three perspective views;

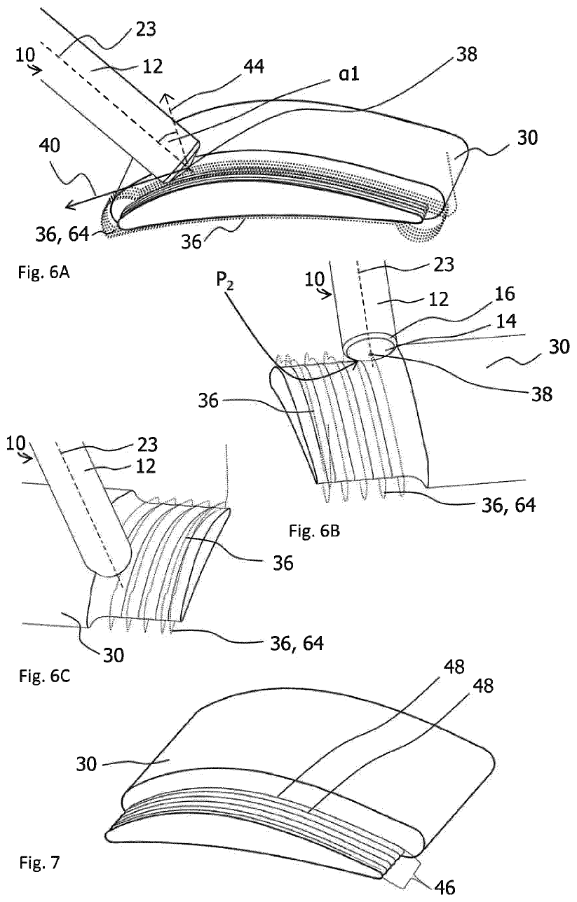

FIGS. 6A-6C are illustrations of roughing a blank portion using a conically convex milling cutter at another machining point using three perspective views;

FIG. 7 is a perspective view of a blank including a rough blank portion;

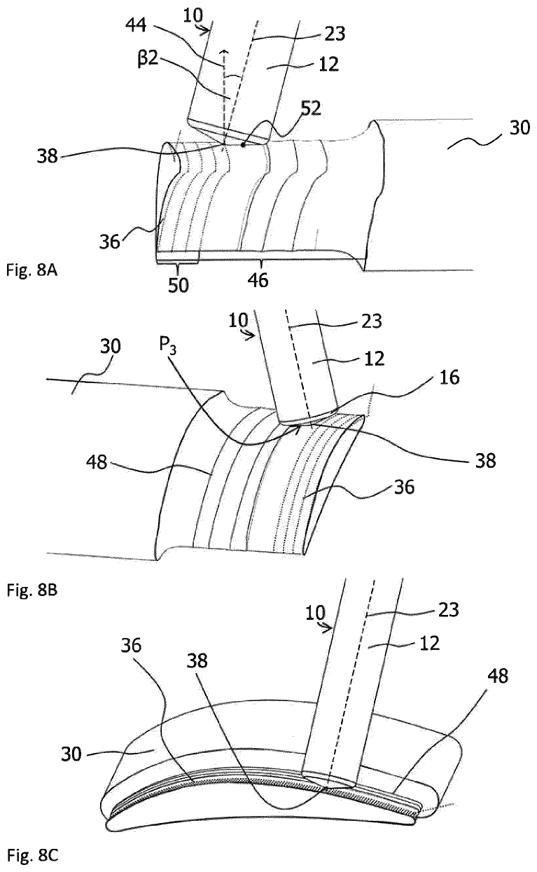

FIGS. 8A-8C are illustrations of finishing a rough blank portion using a conically convex milling cutter at a machining point using three perspective views;

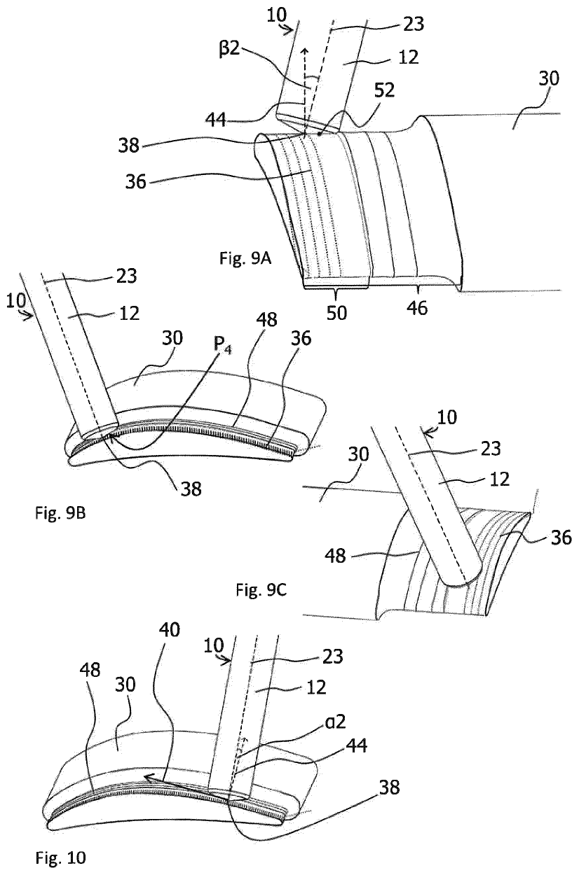

FIGS. 9A-9C are illustrations of finishing a rough blank portion using a conically convex milling cutter at another machining point using three perspective views;

FIG. 10 is an illustration of an alternative of finishing a rough blank portion using a conically convex milling cutter at a machining point;

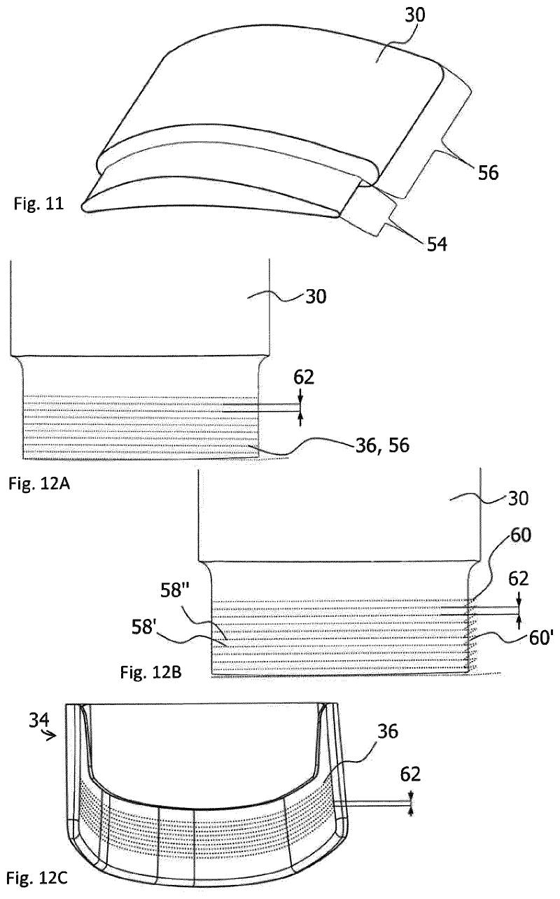

FIG. 11 is a perspective view of a blank including a rough and finished blank portion;

FIGS. 12A-12C are various illustrations visualizing milling paths of the conically convex milling cutter during roughing and/or finishing of a blank without (FIGS. 12A and 12C) and with (FIG. 12B) connecting segments between the milling paths, using the example of a turbine blade (FIGS. 12A and 12B) and an aerospace part (FIG. 12C); and

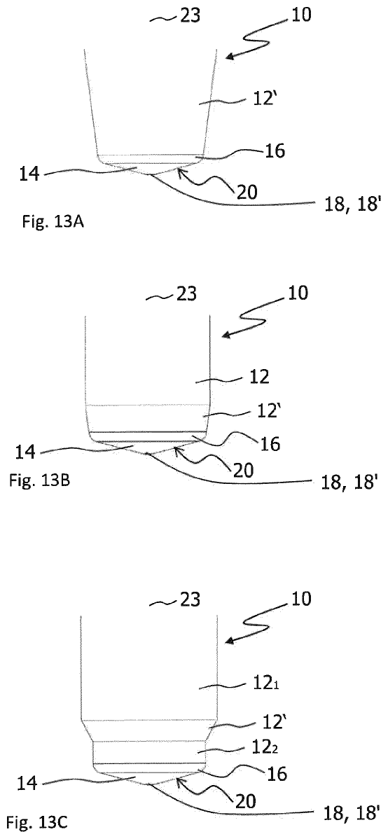

FIGS. 13A-13C show further milling cutter geometries that may be used for implementing the method according to the invention.

FIG. 1A shows a conically convex milling cutter 10 adapted to carry out the method according to the invention. In this embodiment, the milling cutter 10 comprises a substantially cylindrical shank 12 and a conically convex milling cutter portion 14 which in the embodiment shown in FIGS. 1A to 1C is connected to the shank 12 through a transition 16. Further, the milling cutter 10 shown in FIG. 1A has a tip 18 in the form of a ball-shaped tip 18′ on a tapered end side of the conically convex milling cutter portion 14.

The conically convex shape of the milling cutter portion 14 is shown in the enlarged cutout of FIG. 1B in which the dashed line 19 indicates an imaginary rectilinear convex course 19 of a circumferential surface of a cone underlying the milling cutter portion 14 to illustrate an actual curvature radius 22 of the circumferential surface 20 of the conically convex milling cutter portion 14. The curvature radius 22 of the conically convex milling cutter portion may be between 400 mm and 600 mm, preferably between 450 mm and 550 mm, particularly preferably approx. 500 mm.

A cone angle y of the conically convex milling cutter portion 14 between a circumferential surface of a cone underlying the conically convex milling cutter portion 14, which may be defined with respect to the imaginary straight line 19 of the circumferential surface 20 of the milling cutter portion 14, and a longitudinal axis of the milling cutter 23 through the conically convex milling cutter 10 may be between 50° and 85°, preferably 75°.

The transition 16 between the milling cutter portion 14 and the shank 12 is optional. Examples of the milling cutter 10 with and without transition 16 are shown in FIG. 2A and FIGS. 2B and 2C, respectively. Furthermore, the ball-shaped tip 18′ mentioned at the beginning is optional. Alternatively, the milling cutter portion 14 may have a flat tip 18″ at its front tapered end side, as shown in FIGS. 2A and 2C, or any other suitable shape of tip 18. It is understood that the presence of the transition 16 and the choice of the tip 18 of the milling cutter portion are independent features, meaning that, for example, the milling cutter with transition 16 shown in FIG. 2A may also have a ball-shaped tip 18′.

Where there is a transition 16, preferably a ratio of a transition radius 17 to a shank diameter is between 0% and 30%, preferably a transition radius 17 of 0% means that there is no transition radius 17 between the shank 12 and the conically convex milling cutter portion 14.

In the method according to the invention, two steps are carried out, namely a step of roughing and a step of finishing. For this purpose, the conically convex milling cutter 10 may have two cutting areas 24, 26 adapted to the respective step, which may be used for machining in the corresponding steps of the method. As shown in FIG. 3A and FIG. 3C, respectively, the first cutting area 24 is arranged on the shank 12 and, if there is a transition 16, also on the transition 16. The first cutting area 24 may extend along only a portion of the shank 12, the portion of the shank 12 adjoining the conically convex milling cutter portion 14 or the transition 16 if there is such a transition.

Whether or not there is a transition 16, the second cutting area 26 is provided on the conically convex milling cutter portion 14, preferably on its peripheral surface 20, as can be seen in FIGS. 3B and 3D.

If the first cutting area 24 is formed by both the shank 12 and the transition 16, a maximum diameter of the conically convex milling cutter portion 14 may be smaller than a shank diameter. Otherwise, if there is no transition 16 and the first cutting area 24 is disposed solely on the shank 12, the maximum diameter of the conically convex milling cutter portion 14 may be equal to the shank diameter.

A conically convex milling cutter 10 as described above may be used to machine any blank and consequently to manufacture a workpiece 28 of any size and shape. For example, the blank 30 shown in perspective in FIG. 4A, in which the desired workpiece shape is already visible, may be used to manufacture the workpiece 28 shown in FIG. 4B in the form of a turbine blade 32. It is understood that the blank 30 may have any shape, for example, it may have the shape of a cuboid. Alternatively, FIG. 4C shows a workpiece 28 in the form of an aerospace part 34, which may likewise be manufactured using the method according to the invention.

In the following, the method step of roughing will be explained in more detail with reference to FIGS. 5A-5C as well as 6A-6C. As can be seen in these figures, the first cutting area 24 of the conically convex milling cutter 10 is engaged with the blank 30 during roughing. FIGS. 5A-5C show a machining point P1 of the method in which a portion of the blank 30 has already been subjected to roughing and therefore has a reduced material thickness compared to the portion not subjected to roughing.

A visualization of the milling operation completed by the milling cutter 10 may be provided using a milling path 36, which may relate to a reference point 38 on the milling cutter 10, for example, to a tip of the conically convex milling cutter portion 14, as in the embodiment shown in FIGS. 5A to 5C. In FIGS. 5A to 5C, the respective milling path is shown in dashed lines and indicates the path of the milling cutter 10 during roughing of the blank 30 up to the depicted machining point P1.

Referring to FIGS. 5A to 5B, the first machining angle range of the milling cutter 10 at the machining point P1 comprises an angular inclination of the milling cutter 10 in a current feed direction 40 at the reference point 38 at a first camber angle α1. The first camber angle α1 may be defined between the longitudinal axis of the milling cutter 23, shown as a dashed line, and a surface normal 44, shown as a dashed arrow, at a machining point P1 of the blank 30, and may indicate tilting of the milling cutter 10 in the feed direction 40. The feed direction 40 at the machining point P1 is generally perpendicular to the surface normal 44 at that machining point P1. The first camber angle α1 is preferably to be chosen such that the second cutting area 26 of the milling cutter 10 remains passive during roughing of the blank 30. This can be seen, for example, in FIGS. 5A to 5C, in which the conically convex milling cutter portion 14 does not engage with material of the blank 30. The amount by which the camber angle α1 may be larger than a circumferential surface angle θ may depend on the curvature radius 22 of the conically convex milling cutter portion 14. For example, the smaller the curvature radius 22, i.e. the larger the curvature of the conically convex milling cutter portion 14, the larger the amount can be.

In another embodiment (not shown), during roughing, the milling cutter 10 may not only be tilted at the first camber angle α1 in the feed direction 40 but may also be inclined laterally with respect thereto at a first inclination angle β1. The lateral inclination may be chosen depending on the blank 30 or workpiece 28 being machined and may improve cutting conditions or may be essential for collision avoidance. In this embodiment, the first machining angle range includes both tilting the milling cutter 10 in the feed direction 40 at a first camber angle α1 and inclining it laterally, for example transversely, thereto at a first inclination angle β1.

Roughing of the blank 30 at a further machining point P2 is illustrated in FIGS. 6A to 6C; since their perspective views correspond to those in FIGS. 5A to 5C, the previous discussion of FIGS. 5A to 5C applies analogously to FIGS. 6A to 6C. The first camber angle α1 may be different at different machining points P1, P2 of the blank 30 but may also be the same during machining of the entire blank 30 or in a portion thereof. The first camber angle α1 at the further machining point P2 is further defined analogously to the previous discussion of FIG. 5A, namely as a tilting of the milling cutter 10 at the further machining point P2 in the current feed direction 40, wherein the first camber angle α1 may be defined between the longitudinal axis of the milling cutter 23 and the surface normal 44 at the reference point 38.

When machining a blank 30, such as a turbine blade 32, where a thickness is small compared to the length and width, it may be an advantage to machine the blank 30 in portions to avoid unwanted vibration of the blank 30 during roughing or/and finishing due to the movements of the milling cutter 10. A blank 30 in which only a blank portion 46 of the blank 30 was subjected to roughing is shown in FIG. 7. The grooves 48 visible in this blank portion 46 result from a chosen roughing allowance that may vary from portion to portion or also within a portion.

Roughing of the blank portion 46 may be followed by finishing of this blank portion 46 or at least a section thereof. A visualization of the finishing at a machining point P3 is shown in FIGS. 8A to 8C, in which a section 50 of the blank portion 46 has already been finished. The milling path 36, which is also referenced to the tip of the conically convex milling cutter portion 14 in this example, shows the finishing performed up to the machining point shown.

During finishing, the second cutting area 26 of the conically convex milling cutter 10 engages with material of the rough blank portion 46, preferably with a peripheral surface portion of the peripheral surface 20 of the conically convex milling cutter portion 14 contacting material to be finished. This peripheral surface portion of the peripheral surface 20 extends, for example, between the tip 18 of the milling cutter portion 14 and the transition 16 or, if there is no transition 16, the shank 12. A contact point 52 between the peripheral surface portion and the already rough and finished blank portion 46 or the workpiece is highlighted in FIG. 8A by a contact point 52. A precise location of the contact point 52 on the circumferential surface portion in the second cutting area 26 may be fine-tuned through the choice of the lateral second inclination angle β2.

In the example shown, the roughing allowance was chosen to be somewhat larger so that roughing with the first cutting area 24 also takes place during finishing with the second cutting area 26, as can be seen in FIG. 8A, for example. Nevertheless, in this case only the second cutting area 26 has a shaping effect, the first cutting area 24 does not have such an effect.

Referring to FIGS. 8A to 8C, the second machining angle range of the conically convex milling cutter 10 at the machining point P3 includes inclining the milling cutter 10 laterally with respect to a current feed direction 40 at the reference point 38 at a second inclination angle β2. The second inclination angle β2 may be defined between the longitudinal axis of the milling cutter 23, shown as a dashed line, and the surface normal 44, shown as a dashed arrow, and may indicate a lateral inclination of the milling cutter 10 with respect to the current feed direction 40 of the milling cutter 10 at the machining point P3. The second inclination angle β2 is preferably to be chosen such that the second cutting area 26 of the milling cutter 10 engages with material of the rough blank portion 46 during finishing.

Finishing of the rough blank portion 46 at a further machining point P4 is illustrated in FIGS. 9A to 9C; since their perspective views correspond to those in FIGS. 8A to 8C, the previous discussion of FIGS. 8A to 8C applies analogously to FIGS. 9A to 9C. The second inclination angle β2 may be different at different machining points P3, P4 of the rough blank 46, but it may also be the same and remain unchanged during machining of the rough blank portion 46 or a section thereof. The second inclination angle β2 at the further machining point P4 is further defined analogously to the previous discussion of FIG. 8A, namely as a lateral inclination of the milling cutter 10 at the further machining point P4 with respect to the current feed direction 40 of the milling cutter 10, wherein the second inclination angle β2 may be defined between the longitudinal axis of the milling cutter 23 and the surface normal 44 at the reference point 38.

In another embodiment shown in FIG. 10, during finishing, the milling cutter 10 may not only be inclined at the second inclination angle β2 but may also be tilted at a second camber angle α2 in the current feed direction 40. The second camber angle α2 in the feed direction 40 may be defined between the longitudinal axis of the milling cutter 23 and the surface normal 44 at the reference point 38. In this embodiment, the second machining angle range is consequently determined by two angles, the second camber angle α2 in the feed direction and the second inclination angle β2 laterally, for example transversely, thereto.

In general, a first camber angle range in which the first camber angle α1 for roughing can be specified may overlap a second camber angle range in which the second camber angle α2 for finishing can be specified. Alternatively or additionally, a first inclination angle range in which the first inclination angle β1 for roughing can be specified may overlap a second inclination angle range in which the second inclination angle β2 for finishing can be specified. Alternatively, the aforementioned camber angle ranges or/and inclination angle ranges may be ranges separate from each other. A blank 30 comprising the rough and finished blank portion 54 and an unmachined blank portion 56 is shown in FIG. 11. The machining of the blank portion 56 may be performed by roughing and finishing as previously explained. Preferably, another blank portion is first subjected to roughing and then finished for this purpose. The roughing and subsequent finishing of a blank portion may be continued until all blank portions of the blank have been subjected to roughing and finishing, i.e. the machined workpiece 28 is completed. Such alternating, portion-by-portion machining of the blank 30 may increase the blank's stability during milling.

In other words, the roughing and finishing steps are carried out in this sequence and, if necessary, repeated in a further, for example subsequent, blank portion. This procedure is particularly suitable for the manufacture of turbine blades 32, with finishing preferably being carried out only in blank portions that have previously be subjected to roughing.

It is understood that as an alternative roughing of the entire blank may be performed before finishing. However, this procedure is only recommended if the rough blank still has sufficient stability to counteract vibration during subsequent finishing.

Furthermore, it is an advantage if finishing is not performed too close to a transition area between a rough and a non-rough blank portion as a comparatively large amount of material may still be present in this transition area. If this material were to be collected during finishing, the service life of the milling cutter could be reduced due to increased wear. Consequently, the finished blank portion may be smaller than the blank portion previously subjected to roughing. It is understood that the last rough blank portion may be completely finished.

In the following, milling paths 36 usable for roughing and finishing are explained with reference to the illustrations in FIGS. 12A to 12C. The milling path 36 may be closed, as shown in FIG. 12A, and may be, for example, a continuous coil 56. In other words, the milling cutter 10 may be guided continuously, preferably completely, circumferentially around the blank 30 or the rough blank 46 during roughing or/and finishing, preferably continuously contacting the blank 30. A direction of rotation of the milling path 36 may be arbitrary during roughing and/or finishing.

Alternatively, as shown in FIG. 12B, the milling paths 36 may be separate milling paths 58 that may be connected to each other through connecting segments 60 between the milling paths 58. In other words, the milling cutter 10 may, during roughing or/and finishing, pass around the blank 30 or rough blank 46 along a milling path 58′, then be disengaged from the blank 30 or rough blank 46 and guided along a connecting segment 60′ to subsequently re-engage with the blank 30 or rough blank 46 and be guided around the blank 30 or rough blank 46 along another milling path 58″. Preferably, the milling paths 58 run parallel to and separate from each other. The milling cutter 10 may thus be continuously guided around the workpiece 28 using the connecting elements 60.

Independent of a course of the milling path(s) 36, 56, 58, a path distance 62 may be defined between them, for example between revolutions of the continuous coil 56 or the separate milling paths 58. It is calculated, for example, from the tool geometry and the desired accuracy. It is understood that a contour, for example the contour 48 after roughing, may be smoother when the path distance 62 is smaller than when it is larger.

Further, FIG. 12C shows possible milling paths 36 on an aerospace part 34 that are spaced apart by the path distance 62 and extend from one side to the other. In this example, the milling path 36 are not circumferential and, ideally, open on both sides.

In addition to the milling cutter geometry according to the above description with reference to FIGS. 1 to 3, FIGS. 13A to 13C show further alternative milling cutter geometries. While the same reference signs are used for the same components as above, the following description applies additionally.

FIG. 13A shows a milling cutter 10 with a substantially conical shank 12′ that merges into the conically convex milling cutter portion 14 via the transition 16.

FIG. 13B shows a milling cutter 10 with a substantially cylindrical shank portion 12 that merges directly, i.e. without a rounded transition, into a conical shank portion 12′. The conical shank portion 12′ is then followed by the transition 16 that merges into the conically convex milling cutter portion 14.

FIG. 13C shows a milling cutter 10 with a first substantially cylindrical shank portion 121 that merges directly, i.e. without a rounded transition, into a conical shank portion 12′. The conical shank portion 12′ is in turn immediately followed by a second substantially cylindrical shank portion 122 of a smaller diameter. It merges into the conically convex milling cutter portion 14 via the transition 16.

1-17. (canceled)

18. A method for manufacturing a workpiece using a milling tool configured as a conically convex milling cutter, the conically convex milling cutter comprising:
a shank and
a conically convex milling cutter portion connected to the shank directly or through a transition, wherein the conically convex milling cutter has a first and a second cutting area, wherein the first cutting area is provided on the shank or/and at the transition, and wherein the second cutting area is provided on the conically convex milling cutter portion, the method comprising the steps of:
(A) roughing a blank portion using the conically convex milling cutter, wherein the latter is inclined relative to a current feed direction at a reference point of the conically convex milling cutter within a first machining angle range such that machining is performed with the first cutting area of the conically convex milling cutter, wherein the second cutting area remains passive during machining, and
(B) finishing at least a part of the rough blank portion using the conically convex milling cutter, wherein the latter is inclined relative to the current feed direction at the reference point of the conically convex milling cutter within a second machining angle range in such a way that machining is performed with the second cutting area of the conically convex milling cutter, wherein the second cutting area engages with the blank.

19. The method of claim 18, wherein the conically convex milling cutter is variably movable during step (A) of roughing and step (B) of finishing within the first machining angle range and the second machining angle range, respectively.

20. The method of claim 18, wherein the first and the second machining angle ranges overlap or are adjacent to each other or are spaced from each other by an amount.

21. The method of claim 18, wherein step (A) of roughing and step (B) of finishing are carried out alternately on different blank portions.

22. The method of claim 18, characterized in that the conically convex milling cutter is tilted at a first camber angle in the direction of the feed direction of the conically convex milling cutter during roughing) within the first machining angle range.

23. The method of claim 18, wherein the conically convex milling cutter is tilted at a second camber angle in the direction of the feed direction of the milling cutter during finishing) within the second machining angle range.

24. The method of claim 18, wherein in step (A), the conically convex milling cutter is inclined laterally with respect to the feed direction at a first inclination angle during roughing within the first machining angle range.

25. The method of claim 18, wherein in step (B), the milling cutter is inclined laterally with respect to the feed direction at a second inclination angle during finishing within the second machining angle range.

26. The method of claim 18, wherein in step (A) during roughing or/and in step (B) during finishing, a relative movement between the conically convex milling cutter and the blank takes place continuously, wherein:
the conically convex milling cutter moves around the blank or the rough blank or/and
the blank or the rough blank is continuously guided relative to the conically convex
milling cutter along defined milling paths.

27. The method of claim 26, wherein the milling paths differ from each other in step (A) during roughing and in step (B) during finishing.

28. The method of claim 26, wherein the milling paths are spaced apart from each other by defined path distances in step A) during roughing and in step B) during finishing.

29. The method of claim 18, wherein a cone angle between a longitudinal axis of the milling cutter and a circumferential surface of a cone underlying the conically convex milling cutter portion is in an angular range of 50° to 85°.

30. The method of claim 18, wherein a ratio of a transition radius to a shank diameter is between 0% and 30%.

31. The method of claim 18, wherein a ratio of a curvature radius of a peripheral surface of the conically convex milling cutter portion to a shank diameter of the milling cutter is 2 to 50.

32. The method of claim 18, wherein the transition between the shank and the conically convex milling cutter portion is at least one of continuous, gradual and sharp.

33. The method of claim 18, wherein the shank is configured at least one of substantially cylindrical, substantially conical, and conical-cylindrical.

34. The method of claim 18, wherein the shank is composed of different conical portions and cylindrical portions.

35. The method of claim 18, wherein the conically convex milling cutter portion tapers toward a tip or an end face.

36. The method of claim 18, wherein a ball-shaped tip is present at an exposed end of the conically convex milling cutter portion.
